(19) United States
(12) Patent Application Publication
(10) Pub. No.: US 2011/0156295 A1
(43) Pub. Date: Jun. 30, 2011

(54) EMBOSSING ASSEMBLY, MANUFACTURING METHOD THEREOF, AND EMBOSSING METHOD USING THE SAME

(75) Inventors: HSI-CHANG WU, Tu-Cheng (TW); TAI-CHERNG YU, Tu-Cheng (TW)

(73) Assignee: HON HAI PRECISION INDUSTRY CO., LTD., Tu-Cheng (TW)

(21) Appl. No.: 12/758,128

(22) Filed: Apr. 12, 2010

(30) Foreign Application Priority Data
Dec. 24, 2009 (TW) 98144655

(51) Int. Cl. B29D 11/00; B28B 3/12; C25D 1/10

(52) U.S. Cl. 264/2.1; 425/471; 205/70

(57) ABSTRACT

A method of manufacturing a brightness enhancement film includes the following: providing a embossing substrate, providing a first embossing assembly including a roller and an embossing layer applied on the roller, which is formed by electroforming and includes protruding micro-structures formed on the outer surface of the embossing layer, rolling the embossing layer onto the embossing substrate, and embossing the recessed micro-structures on a surface of the embossing substrate.

### BACKGROUND

1. Technical Field

The present disclosure generally relates to an embossing assembly, a method of manufacturing the embossing assembly, and a method of embossing brightness enhancement film using the embossing assembly.

2. Description of Related Art

Backlight modules are critical components of a liquid crystal display, such as those used in a mobile phone or digital camera. A commonly used backlight module generally includes a brightness enhancement film to optimize optical properties.

A roll-to-roll process having higher manufacturing efficiency and lower manufacturing cost is often used to fabricate the brightness enhancement film. A roller for embossing arrays of structural features on a substrate, such as a plurality of micro-structures, rolls on and embosses the substrate to imprint a plurality of micro-structures thereon. Generally, the roller is provided with a plurality of micro-structures formed on the outer surface thereof. The micro-structures are commonly formed by die cutting the roller surface employing machine cutting, laser etching, or laser carving, such that the micro-structures are recessed. When rolling the substrate during fabrication of a brightness enhancement film, a plurality of correspondingly protruding micro-structures are embossed on the substrate. The resulting brightness enhancement film is, however, relatively thick due to the protruding micro-structures.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of one embodiment of an embossing assembly.

FIG. 2 is a flowchart of one embodiment of a method of manufacturing an embossing assembly, such as, for example, that of FIG. 1.

FIG. 3 shows the manufacturing process of FIG. 2.

FIG. 4 is a flowchart of a method of manufacturing brightness enhancement film, performed by an embossing assembly such as, for example, that of FIG. 1.

FIG. 5 shows a method of embossing brightness enhancement film.

### DETAILED DESCRIPTION

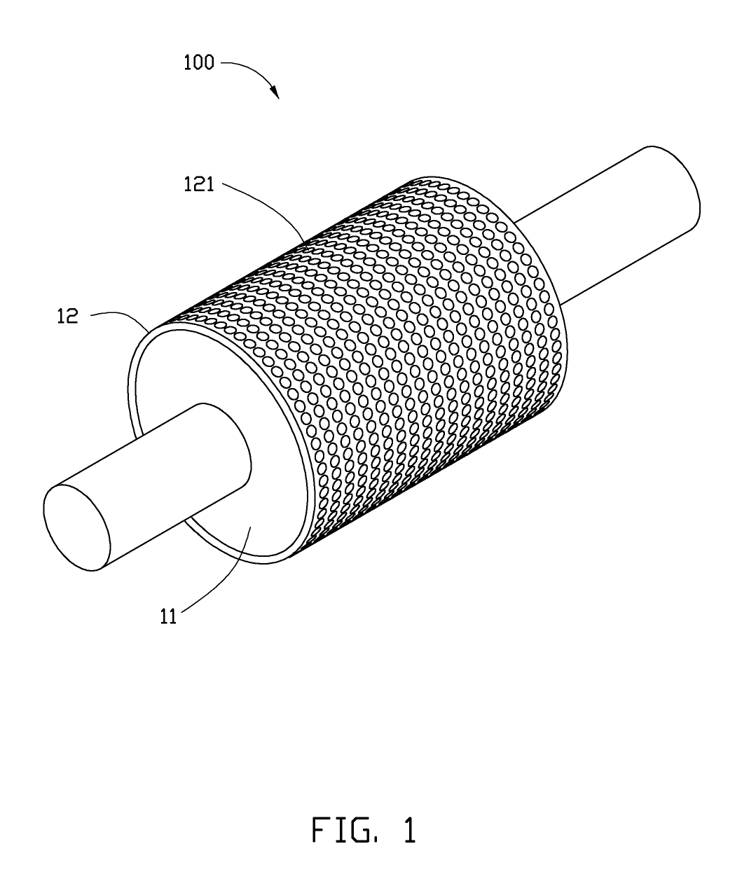

Referring to FIG. 1, an embossing assembly 100 includes a roller 11 and an embossing layer 12 applied on the roller 11 according to one embodiment of the present invention. The embossing layer 12 is formed by electroforming and includes a plurality of protruding micro-structures 121 formed on an outer surface of the embossing layer 12. The protruding, substantially hemispherical micro-structures 121 are rigid, and are arranged in a matrix. When the embossing layer 12 is rolled on a substrate, a plurality of recessed micro-structures are formed on the substrate corresponding to the protruding micro-structures 121. Alternatively, each protruding micro-structure 121 may be a prism.

The roller 11 may be made of a thermally conductive material, such as aluminum, copper, zinc, nickel, iron, titanium, cobalt or an alloy thereof. The embossing layer 12 is made of a thin flexible layer of electroforming material, such as nickel, platinum-nickel-cobalt, cobalt-tungsten, gold or silver.

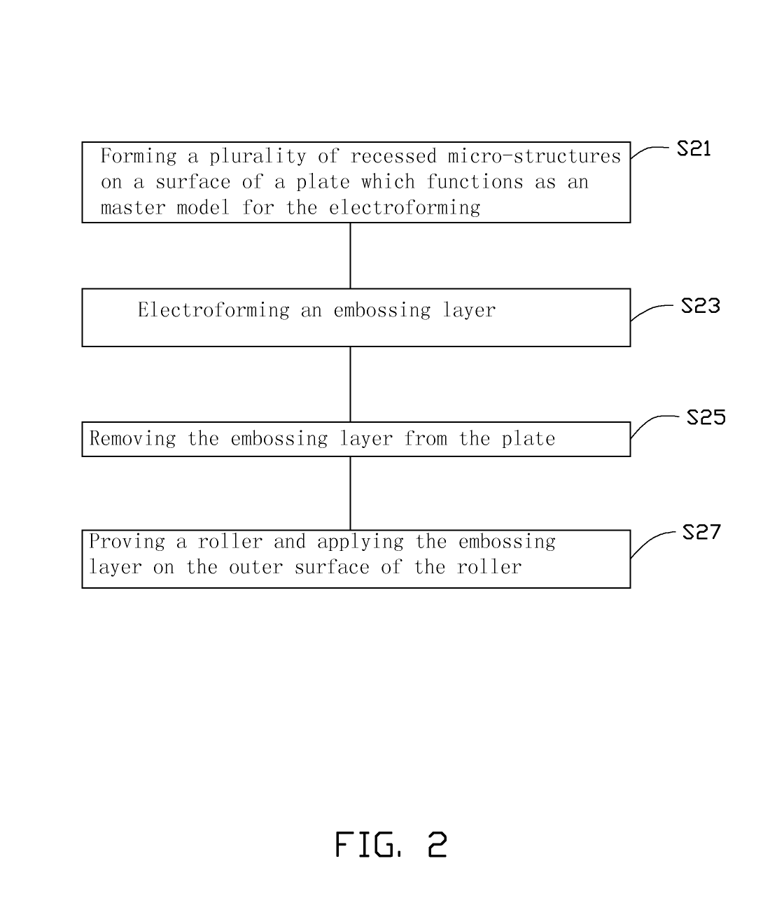

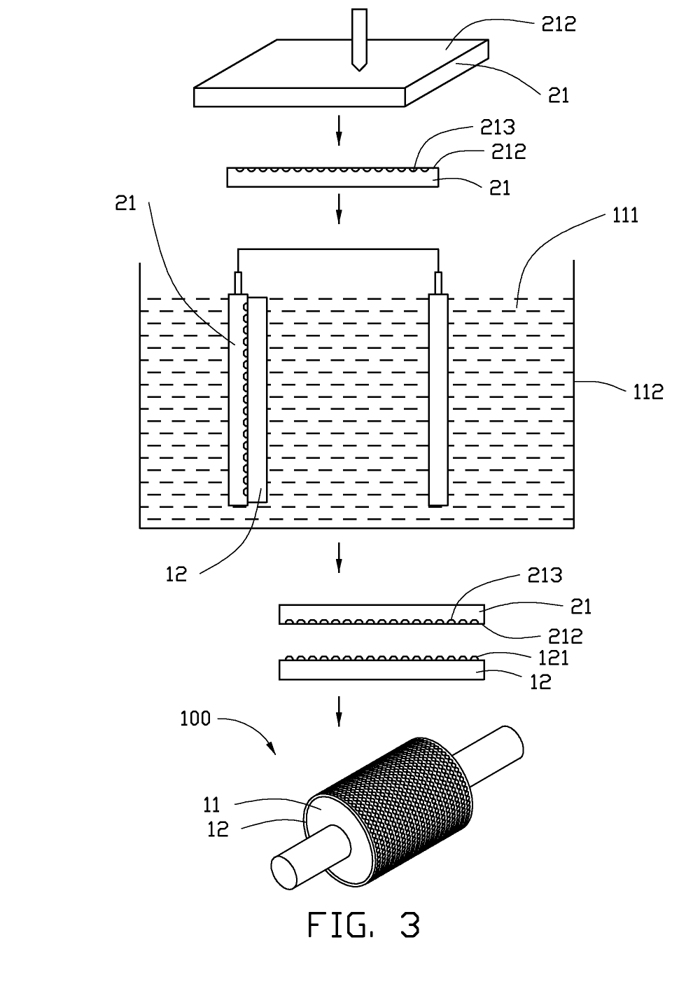

Referring to FIGS. 2 and 3, a method of manufacturing an embossing assembly 100 follows.

In step S21, a plurality of recessed micro-structures 213 is formed on a surface 212 of a plate 21 which functions as a master mold for the electroforming.

The plate 21 is a substantially flat and rectangular plate. The recessed micro-structures 213 may be substantially hemispherical and arranged in a matrix. The recessed micro-structures 213 may be formed by laser etching, laser carving, machine cutting or casting. Alternatively, the recessed micro-structures 213 can also have an irregularly curved surface.

In step S23, an embossing layer 12 with a plurality of protruding micro-structures 121 thereon is electroformed together with the plate 21 functioning as a master mold.

During the electroforming process, the plate 21 with the embossed recessed micro-structures 213 thereon is placed in an electrolytic bath 112 containing an electrolytic solution 111, wherein a thin coating layer is deposited on the surface 212 of the plate 21 to form an embossing layer 12. A plurality of protruding micro-structures 121 is formed on a surface of the embossing layer 12 that is adjacent and touching the plate 21. The protruding micro-structures 121 correspond to the recessed micro-structures 213 on the plate 21. The embossing layer 12 may be a thin flexible layer of nickel, platinum-nickel-cobalt, cobalt-tungsten, gold or silver.

In step S25, the electroformed embossing layer 12 is detached from the plate 21. An oxidation film or graphite layer can be formed on the surface 212 of the plate 21 to facilitate removal of the embossing layer 12.

In step S27, a roller 11 is provided, and the embossing layer 12 is applied on the outer surface of the roller 11. The embossing layer 12 is secured to the roller 11 by welding, rivets, or other means.

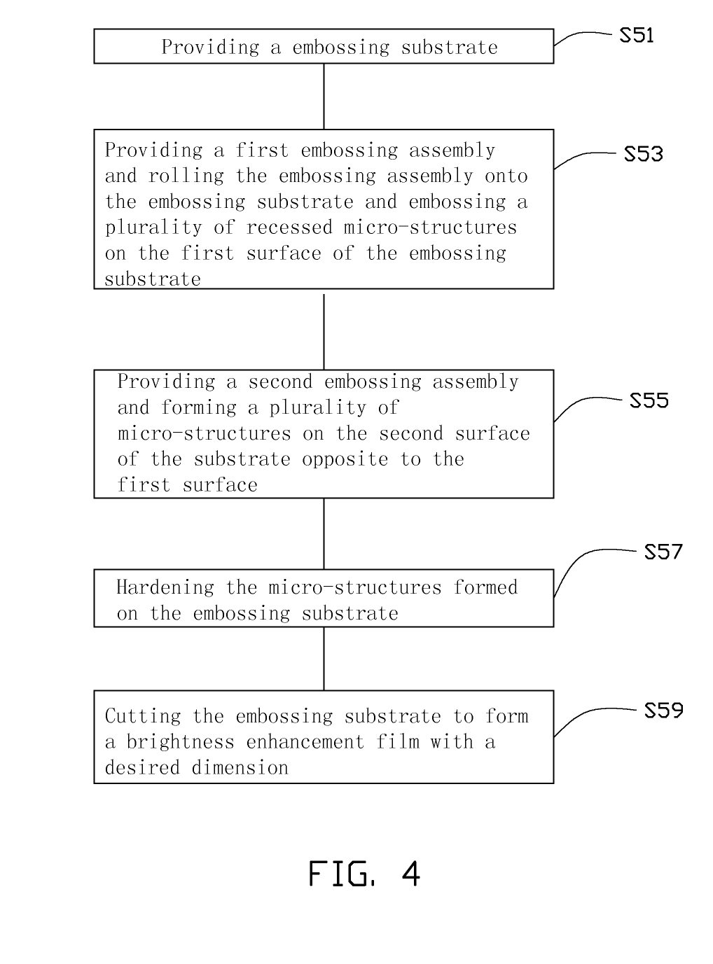

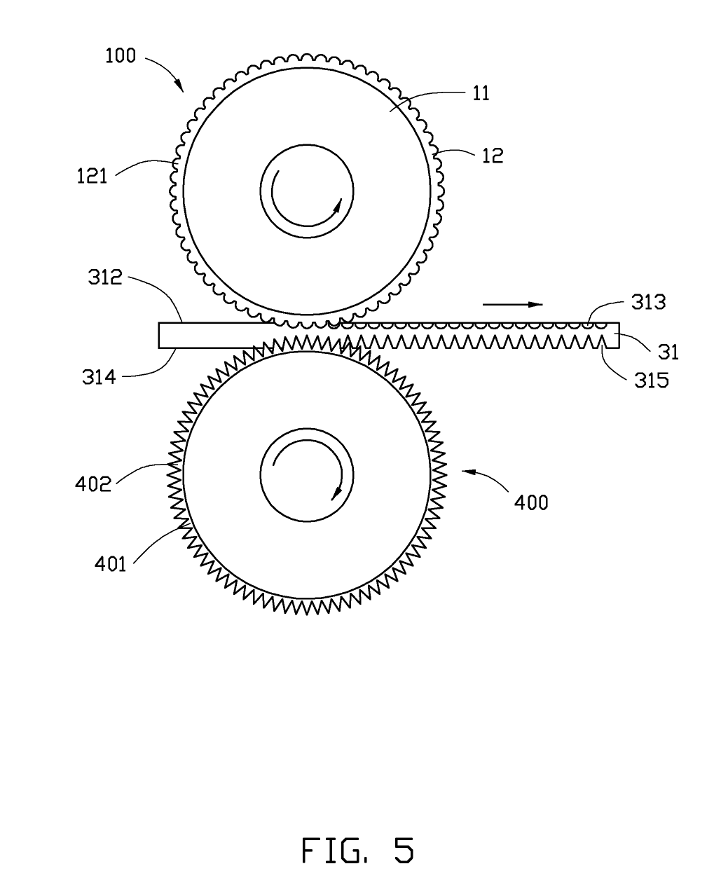

Referring to FIGS. 4 and 5, one embodiment of a method of manufacturing a brightness enhancement film follows. The method employs a roll-to-roll process to emboss micro-structures.

In step S51, an embossing substrate 31 is provided. The embossing substrate 31 is a flexible thin sheet having a first surface 312 and a second surface 314 opposite to the first surface 312. A resin layer may be coated on the first and second surfaces 312, 314, and the embossing substrate 31 may be preheated before embossing.

In step S53, a first embossing assembly is rolled onto the embossing substrate 31 and forms a plurality of recessed micro-structures 313 on the surface 312 of the embossing substrate 31.

The embossing assembly 100 described functions as a first embossing assembly here. Since the embossing layer 12 of the embossing assembly 100 includes a plurality of protruding micro-structures 121, a plurality of first recessed micro-structures 313 are thereby embossed onto the first surface 312 of the embossing substrate 31.

In step S55, a second embossing assembly 400 is rolled onto the second surface 314 of the embossing substrate 31 and embosses a plurality of second recessed micro-structures 315 on the second surface 314.

In the illustrated embodiment, the second embossing assembly 400 includes a roller 401 and a plurality of protruding micro-structures 402 formed on the outer surface of the roller 401. The first and second embossing assemblies 100 and 400 are placed on opposite sides of the embossing substrate 31, and rotated in opposite directions. As the steps S53 and S55 are implemented simultaneously, and the embossing substrate 31 is fed continuously, the first and second recessed micro-structures 313, 315 are thereby embossed on the first and second surfaces 312 and 314, respectively. The protruding micro-structures 402 may be substantially V-shaped and formed by machine cutting. Alternatively, the embossing assembly 100 can also function as the second embossing assembly, such that, the embossed recessed micro-structures on both the first and second surfaces 312, 314 are thereby substantially equivalent.

In step S57, the micro-structures embossed on the embossing substrate 31 are hardened. The micro-structures 313, 315 which are depressed/recessed may be hardened by UV radiation or heat.

In step S59, the embossing substrate 31 with micro-structures formed thereon are cut to achieve a desired dimension to form a brightness enhancement film (not shown).

The above disclosed method allows continuous embossing of the brightness enhancement film, thus achieving a higher manufacturing efficiency and lower cost. Since the recessed micro-structures 313 can be formed on the surface of embossing substrate 31, the brightness enhancement film can achieve a relatively thin profile.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

1. An embossing assembly, comprising:
a roller; and
an embossing layer applied on the roller, wherein the embossing layer is formed by electroforming and comprising a plurality of protruding micro-structures on the outer surface of the embossing layer.

2. The embossing assembly of claim 1, wherein the embossing layer is made of a thin layer of nickel, platinum-nickel-cobalt, cobalt-tungsten, gold or silver.

3. The embossing assembly of claim 1, wherein each of the plurality of protruding micro-structures is substantially hemispherical.

4. The embossing assembly of claim 1, wherein each of the plurality of protruding micro-structures is substantially a prism.

5. A method of manufacturing an embossing assembly, comprising:
forming a plurality of recessed micro-structures on a surface of a plate, wherein the plate functions as a master mold;
electroforming an embossing layer comprising a plurality of protruding micro-structures corresponding to the recessed micro-structures on the plate;
removing the embossing layer from the plate; and
providing a roller and applying the embossing layer on the outer surface of the roller.

6. The method of manufacturing an embossing assembly of claim 5, wherein the plate is substantially flat.

7. The method of manufacturing an embossing assembly of claim 6, wherein the recessed micro-structures are formed by machine cutting.

8. The method of manufacturing an embossing assembly of claim 6, wherein the recessed micro-structures are formed by laser etching or laser carving.

9. The method of manufacturing an embossing assembly of claim 5, wherein the embossing layer is made of a thin layer of nickel, platinum-nickel-cobalt, cobalt-tungsten, gold or silver.

10. The method of manufacturing an embossing assembly of claim 5, wherein each recessed micro-structure is substantially hemispherical.

11. The method of manufacturing an embossing assembly of claim 5, wherein each recessed micro-structure is substantially a prism.

12. A method of manufacturing a brightness enhancement film, comprising:
providing an embossing substrate;
providing a first embossing assembly, the first embossing assembly comprising:
a roller;
an embossing layer applied on the roller, wherein the embossing layer is formed by electroforming and comprises a plurality of protruding micro-structures formed on the outer surface of the embossing layer; and
rolling the embossing layer onto the embossing substrate and embossing a plurality of first recessed micro-structures on a first surface of the embossing substrate.

13. The method of manufacturing a brightness enhancement film of claim 12, wherein each protruding micro-structure is substantially hemispherical.

14. The method of manufacturing a brightness enhancement film of claim 12, wherein each of the protruding micro-structures on the embossing layer is substantially a prism.

15. The method of manufacturing a brightness enhancement film of claim 12, further comprising: providing a second embossing assembly and forming a plurality of second recessed micro-structures on a second surface of the embossing substrate opposite to the first surface.

16. The method of manufacturing a brightness enhancement film of claim 15, wherein the second embossing assembly comprises a roller and a plurality of protruding micro-structures formed on the outer surface of the roller.

17. The method of manufacturing a brightness enhancement film of claim 16, wherein the protruding micro-structures on the roller of the second embossing assembly are substantially V-shaped.

18. The method of manufacturing a brightness enhancement film of claim 17, wherein the protruding micro-structures on the roller of the second embossing assembly are formed by machine cutting.

19. The method of manufacturing a brightness enhancement film of claim 12, further comprising hardening the micro-structures formed on the embossing substrate.

20. The method of manufacturing a brightness enhancement film of claim 19, wherein the micro-structures are hardened by UV (ultraviolet) radiation.
